(19) United States
(12) Patent Application Publication
(10) Pub. No.: US 2020/0124101 A1
(43) Pub. Date: Apr. 23, 2020

(54) In Situ Lubrication of Thin Section Bearings

(71) Applicant: Adolfo Rivera, Newburgh, NY (US)

(72) Inventor: Adolfo Rivera, Newburgh, NY (US)

(21) Appl. No.: 16/163,907

(22) Filed: Oct. 18, 2018

(51) Int. Cl. F16C 33/66; F16C 32/04; F16C 33/32; F16C 33/58

(52) U.S. Cl. CPC F16C 33/6659; F16C 33/58; F16C 33/32; F16C 32/04

(57) ABSTRACT

A lubrication system for an enclosed rolling element bearing may be achieved through a channel drilled through the outer race of the bearing and the outer surface of the bearing housing. The channel provides a direct path for the injection of lubricant via a grease gun or syringe to reach the rolling elements within. The lubrication system can be adjusted to assure lubricant does not leak from the channel with the addition of a tube or hollow screw or combination of the two along the entirety of the channel.

### FIELD

The present disclosure relates generally to in-situ lubrication of thin section bearings and more specifically to the structure for and methods of applying new lubricant to a roller element bearing through a channel, which eliminates the need for removal of the bearing from its housing(robot) or replacement of the bearings.

### BACKGROUND

Industry practice for many roller element bearings, such as deep groove ball bearings, needle roller bearings, self-aligning ball bearings, spherical roller bearings, roller thrust bearings and thin section bearing applications require removal or replacement of a bearing before the end of its useful life, due to inadequate levels of lubrication. Alternatively some users of bearings run the bearings to failure (typically between 6 months and 5 years). A recent study concluded that up to 80% of bearing related failures are due to lubricant starvation/depletion. A bearing that does not maintain the required amount of lubrication throughout its life will start to degrade in quality as both the lubricant and the bearing components begin to wear. This wear produces increased rotational friction, particles, spent lubricant, metal fluorides, and metal oxides that reduce the bearing's effectiveness and could spray out and contaminate sensitive components close to the bearing housing. For these reasons, the industry practice is to totally replace each bearing before it fails due to insufficient residual lubricant or after it has been run to failure.

Replacing bearings altogether is wasteful because it is time consuming and bearings are very expensive and are not meant to be used as a consumable product.

Many bearings used in aerospace, defense, robotics and automation are designed with shields or seals to prevent lubrication from escaping the bearing enclosure and spraying onto surrounding objects, causing contamination. These types of bearings are lubricated for life, so once the lubrication is used up or significantly degraded, it is impossible to re-lubricate and the bearing must be removed and replaced.

Open, shielded or sealed thin section bearings are often used in semiconductor manufacturing equipment. These systems typically are composed of various tools and robots within a vacuum chamber. To replace a bearing within this system, all chambers must be vented up to atmospheric conditions. Robots housing the bearings are removed, bearings are replaced and the robots are reinstalled. When the chambers are vented the metal shields that protect the process chamber walls from process metal deposition must be replaced, as the old metal deposits will begin to flake off as soon as they are exposed to atmosphere. Once the bearings have been replaced, the entire system must be recalibrated. The quality of this calibration depends on the skill level of the technician performing it. This is an expensive and time consuming process that could lead to wafer breakage if the system has not been recalibrated to match its previous performance. Also, once the chamber has been pumped back down to vacuum, the chamber must be qualified for production by burning in metal targets using monitor wafers. The above processes are invasive and extended downtime in manufacturing equipment can be very expensive in terms of lost production, especially in complex modern semiconductor fabrication facilities, such as those producing Nano electronics.

### SUMMARY

Accordingly, it is an object of one or more embodiments of the present disclosure to reduce the inefficiency of replacing inadequately lubricated bearings and to eliminate run to failure situations, thus improving predictability, reliability and productivity in the systems in which they are used.

It is a further object of one or more embodiments of the disclosure to provide a method of quickly and cost effectively re-lubricating bearings without removing them.

Other objects will appear hereinafter.

The above and other objects of the present disclosure may be accomplished in the following manner.

A lubrication system for an open or enclosed rolling element bearing may be achieved through a channel drilled through the outer surface of the bearing housing and the outer race of the bearing. The channel provides a direct path for the injection of lubricant via a grease gun or syringe to reach the rolling elements within.

The lubrication system can be adjusted to assure lubricant does not leak from the channel with the addition of a hollow screw or tube along the entirety of the channel.
The objects are further achieved by a lubrication system for a rolling element bearing having an outer race, and inner race, and a plurality of rolling elements within the bearing, and a shield or seal on both sides of the bearing. A channel is provided through the bearing housing and through a hole in the outer race and inner surface of the bearing, for adding lubricant to the bearing. A lubrication block includes a second channel, to connect the first channel to the bearing through a hole in the shield.

### BRIEF DESCRIPTION OF THE DRAWINGS

The present disclosure will be more clearly understood from the following description taken in conjunction with the accompanying drawings in which like reference numerals designate similar or corresponding elements, regions and portions and in which:

FIG. 1 shows a cross sectional view of a first preferred embodiment of the present disclosure for an in situ lubricator adapter.

FIG. 2 is a top view of FIG. 1.

FIG. 3 illustrates a cross-sectional view of the embodiment of FIG. 1 in a four-point contact thin section bearing.

FIGS. 4 and 5 show a top view the embodiment of FIG. 1 in a four-point contact thin section bearing mounted on a robot vacuum magnet assembly, with the bearing shield cut away for better visualization.

FIG. 6 illustrates a side view of a second embodiment of the disclosure, which includes the in situ lubricator block.

FIG. 7 shows a top view of the second embodiment in a four-point contact thin section bearing mounted on a robot vacuum magnet assembly.

FIG. 8 shows an inside side view of the 2nd embodiment, with two bearings mounted on a robot vacuum bearing magnet assembly.

FIGS. 9 and 10 demonstrate a side view and isometric view, respectively, of a third embodiment of the disclosure.

FIG. 11 illustrates a cross-sectional view of a fourth embodiment of the disclosure, which includes a ball point pen socket lubricator.

FIGS. 12 and 13 show a cross-sectional side view and top view, respectively, of a fifth embodiment of the disclosure, showing a 360 degree lubrication reservoir gland.

FIG. 14 illustrates a cross-sectional side view of a fifth embodiment of the disclosure, including a lubricant scavenger retainer.

### DESCRIPTION

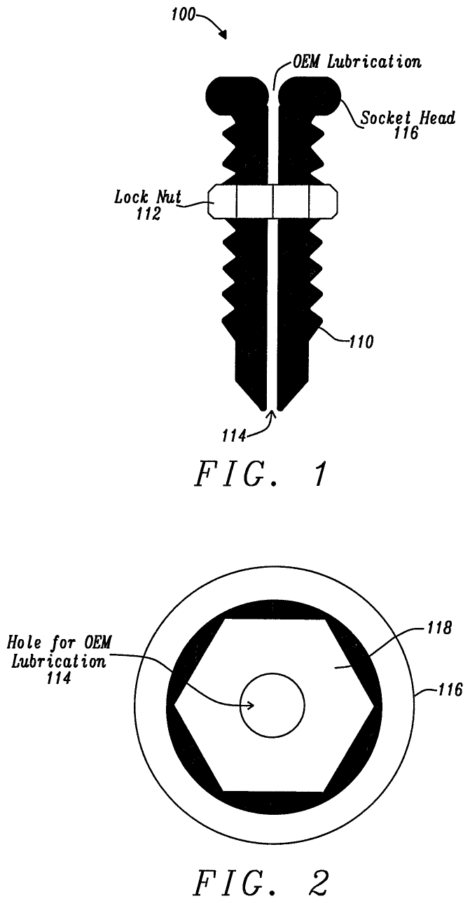

FIG. 1 is a cross-sectional view of an in-situ lubricator adapter 100. A first and most general embodiment of the lubricator adapter is a hole through the outer race of a roller element bearing and the outer surface of the bearing housing. A tube can be added to this channel to assure there is no leaking along the path the lubricant flows upon. The in-situ lubricator adapter 100 is inserted into an outer portion of the hole in the bearing housing and is preferably made up of a threaded screw 110 with a cylindrical chamber 114 drilled through its core to allow lubricant to freely flow to the bearing enclosure. A lock nut 112 is attached to the threaded screw 100 to keep the threaded screw in place on the bearing. A threaded screw helps to establish a channel and prevents lubricant from leaking.

An alternative to the screw and lock nut is, for example, a hollow tube glued or pressure fitted into a hole in the bearing housing and a hole in the outer bearing race, or a combination of the screw, lock nut, and tube. A mini grease gun or syringe can be used to insert lubrication into channel 114 through the socket head 116 end of the screw. A removable cap or plug can be used at the socket head end of the cylindrical chamber or tube to keep the lubricant from escaping out the top of the chamber.

FIG. 2 shows the in-situ lubricator adapter 100 from a top view, including socket head 118. The screw size and type along with the diameter of the hole through the screw will be dependent on the bearing application. As one example only, an 8/32″ screw can be used on thin section bearings with bore sizes of 6 to 16 inches.

A cross sectional view is illustrated in FIG. 3 showing the in-situ lubricator adapter 100 inserted into a four-point contact thin section bearing 300. Thin section bearings are manufactured in many sizes, up to a 40-inch inner diameter, and configurations. These bearings often include shields or seals on one or both sides of the bearings or no shields at all. Such bearings often have balls as the rolling elements of the bearing. The balls can be made of a variety of materials including tungsten carbide, brass, stainless steel and ceramic materials.

There are three different types of thin section bearings. The C-Type is a radial contact bearing design with a single row of balls. The A-Type thin section bearing is an angular contact bearing with a reduced shoulder on either the inner or outer race ball path. The A-Type requires a thrust load to establish the appropriate contact angle between the races and balls. The third type of thin section bearing is the X-Type, a 4-point contact bearing which provides a high level of rigidity. X-Type bearings are designed with Gothic raceways which provide four points of contact between a ball and the raceway. This disclosure primarily concerns X-type thin section bearings, which are found in the hub/waist bearings in magnetically coupled robotic semiconductor manufacturing equipment from companies such as Applied Materials, and include Endura, Endura XP, Centura and Producer Robots (all products of Applied Materials, Santa Clara, Calif.).

Roller element bearings as disclosed are typically mounted on a housing that the outer bearing race is pressed into. The inner race is mounted on a shaft or spindle that goes through it's center. Depending on application either the shaft/spindle or the housing is stationary, allowing the free race to rotate while the other race is static. For purpose of clarity the housing (such as a vacuum magnet assembly) and shaft have been omitted in most of the drawings to follow. In a common application of the disclosure for use with a vacuum magnet assembly, the inner race is mounted on a shaft/hub and remains stationary. The outer race is not pressed into the vacuum magnet assembly but remains magnetically bonded and rotates at the same time and speed as the vacuum bearing magnet assembly.

The “X” 312 included in FIG. 3 and all other Figures refers to an X-type thin section bearing, where the lines of the X denotes where the ball 314 contacts the surrounding raceway 326. This bearing includes a shield 316 on each side of the balls. The adapter 100 could include a partially threaded portion 322 with a non-threaded extension 324 inserted into a hollow chamber 320 which is drilled through a housing 330 and the outer race 310 of the thin section bearing 300. The inner race 318 is enclosed and inaccessible unless the bearing is taken out of its assembly.

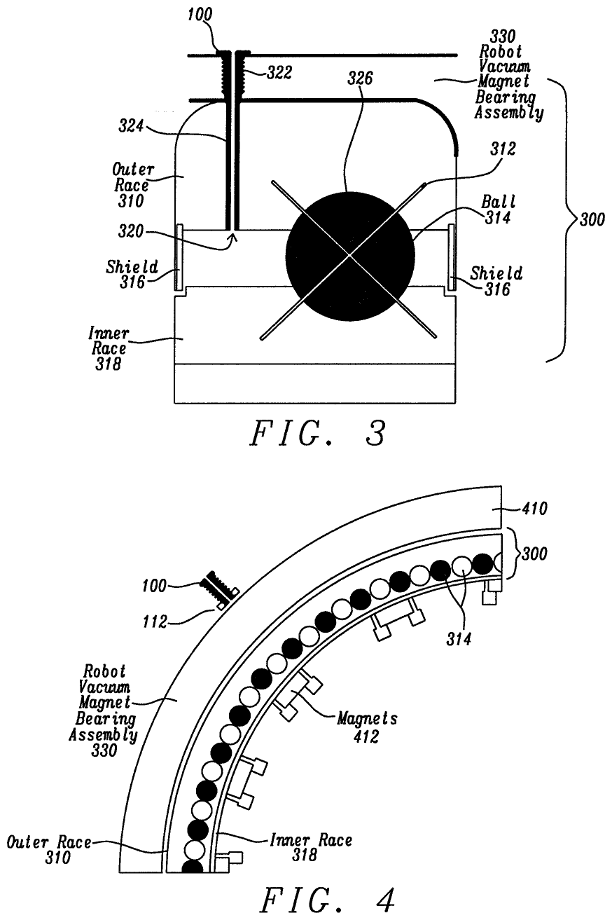

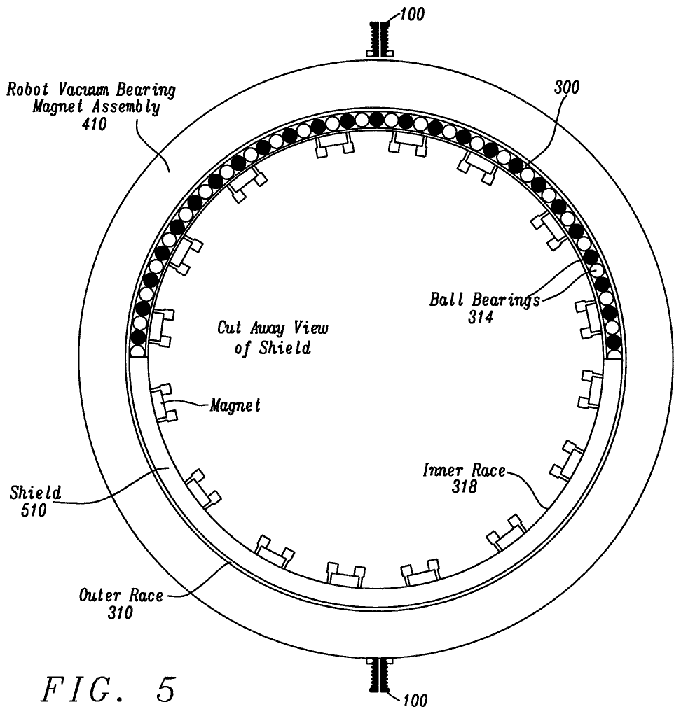

FIG. 4 shows a top view of a typical assembly of a 4 point contact thin section bearing 300 mounted on a robot vacuum magnet assembly (or housing) 330, including magnets 412. All bearing housings impede direct re-lubrication. In this application the robot vacuum magnet assembly impedes direct re-lubrication. The in-situ lubricator adapter 100 is attached through the housing 410 and outer race 310 and ends in a position just above the balls 314, which in this example include a hybrid of stainless steel and ceramic balls. This disclosure can be applied to all types of rolling element bearings as well as the 3 types of thin section bearings, with or without shields or seals and regardless of the size or type of bearing balls or roller elements. This figure demonstrates an exemplary application of the disclosure, as one example in which direct lubrication is impossible.

FIG. 5 shows a full top view with the shield partially cut away for visualization of the embodiment of FIG. 4, a 4 point thin section bearing 300 mounted on a robot vacuum magnet assembly 410. This figure demonstrates the possibility of having two or more adapters 100 mounted on a single bearing. This can speed up the re-lubrication process either by providing two input channels (helpful with very large inner diameter bearings) or one entrance point for adding lubricant, and one exit point for spent lubricant. The latter would be helpful in sealed bearings which would benefit from an exchange of the lubricant. The end point of the adapter 100 at the bottom of the figure is hidden by the shield 510, wherein the adapter ends under the shield and above the balls 314.

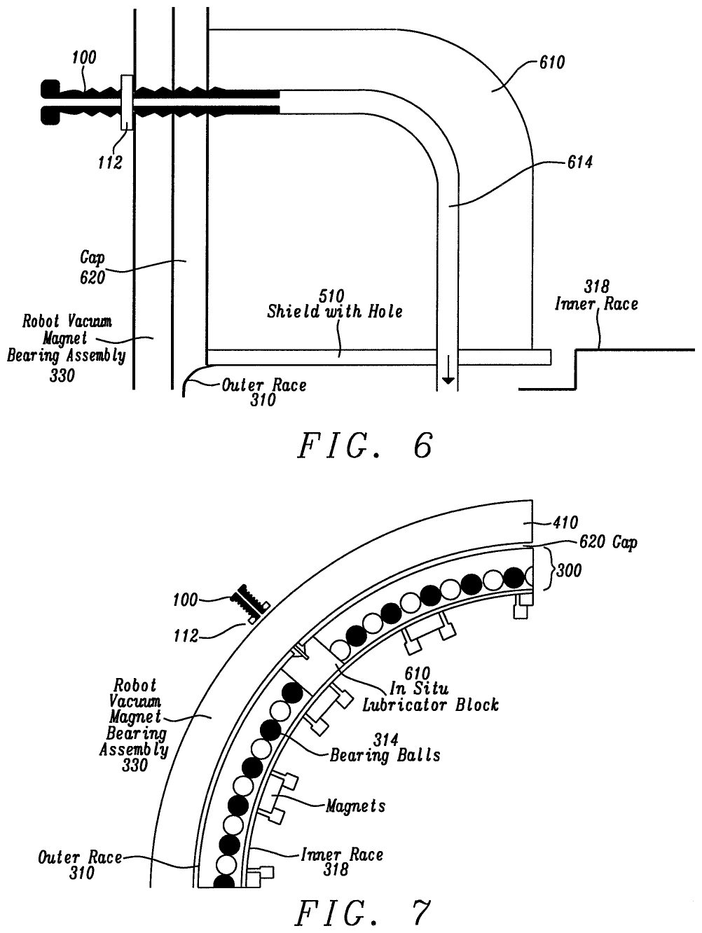

FIGS. 6-7 and 8 demonstrate a second embodiment of the disclosure, in particular an in situ lubricator block 610. The first embodiment as shown in FIGS. 3-5 provides for direct access into the side, for a horizontally-oriented bearing, of the bearing, through the outer race. The lubricator block is an alternative way to provide a channel to deliver lubrication into the bearing, without going through the outer race. Rather, for such a horizontally-oriented bearing, the channel allows lubricant to enter from above—as shown in FIG. 6—or below. The lubricator block may be desirable for an open bearing, or for a bearing having shields, seals, or a combination of shields and seals, or for bearing assemblies for which direct connection of a channel through the bearing housing and into the bearing is not possible. Whereas in the first embodiment the channel is, preferably, formed in a straight line from outside the housing into the bearing, the second embodiment provides a channel with at least one change in direction.

Dimensions of the lubricator block 610 depend on available space for mounting and installation within the assembly that includes the bearing. The lubricator block can be held in place by the in situ lubricator adaptor. Two screws could be used for greater assurance, or a combination of screws and adhesive could be used.

FIG. 6 shows a side view of the lubricator block 610 working in conjunction with the lubricator adapter 100, with a channel formed through the housing 330, gap 620 and then into lubricator block 610, with the channel turning 90 degrees (in this embodiment) to extend down through shield 510 into the bearing. Gap 620 eliminates the need to press the outer race 310 into the housing. The inner race 318, in one application, is held stationary by a shaft, and the outer race is held in place by magnets. Also shown are the outer race 310 and inner race 318. The lubricator block is a precision machined component that allows a versatile alternate access point to the ball bearings. The channel 614 provides a path for lubricant through the bearing shield (or seal) 510.

FIG. 7 shows a top view of the adapter 100 drilled through the housing 410 of a 4 point thin section bearing 300 mounted on a robot vacuum magnet assembly 410. The adapter 100 is connected to a lubricator block 610 which is located above the bearing balls 314, providing a continuous path for lubricant flow. In this embodiment, the adapter attaches through the bearing housing (vacuum bearing magnet assembly) 410 as before, and the adapter 100 terminates inside the lubricator block 610. The lubricator block 610 provides a channel to the bearing balls 314 and through any shield or seal, to insure that lubrication is properly applied.

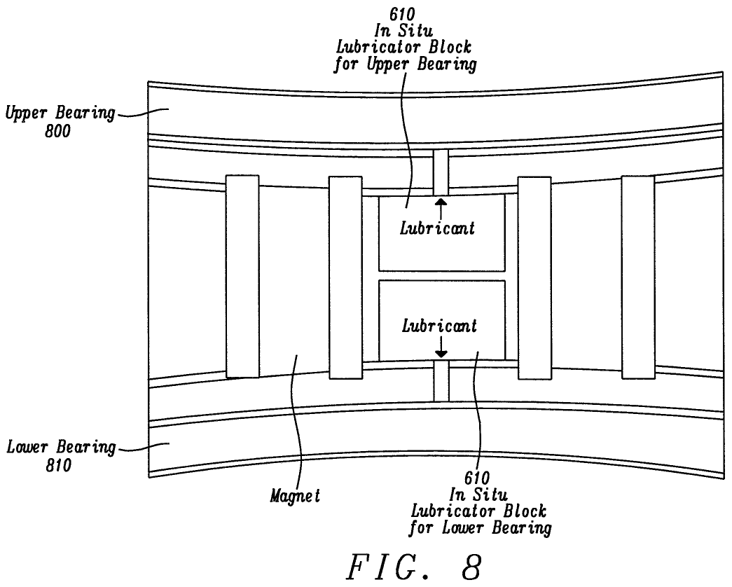

FIG. 8 demonstrates the versatility of the combination of the adapter 100 and the lubricator block 610. This figure shows an assembly in which there are two bearings, upper bearing 800 and lower bearing 810, mounted face to face. There could be two sets of adapter-lubricator blocks 610 stacked on each other, one for the top bearing and one for the bottom. Preferably, one in situ lubricator adapter (not shown) would be used for each lubricator block 610.

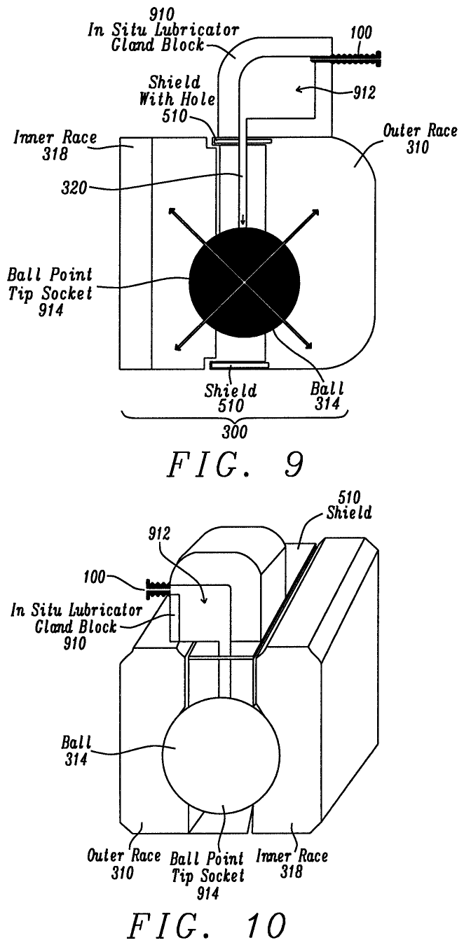

In a further embodiment, an in-situ lubricator gland block 910, including gland (or reservoir) 912, is disclosed, as shown in FIG. 9. This gland block allows even more flexibility and control over how much lubrication is provided to the bearing 300. The gland block can have, for example, square or rectangular cross-section, and preferably has dimensions of about ¼″ by ¼″, increasing in size depending on the bearing size and bearing assembly configuration. The gland block 910 has an internal cavity 912 that serves as a reservoir for lubrication, which can be released on demand. In this example, the channel 320 could be a stainless steel tube that ends in a ball point tip socket 914 which provides contact against the ball bearings 314 pulling lubricant from the gland block 910 as the balls roll. This socket 914 is designed to work similarly to a ball point pen. The socket can be held in place by two prongs set 180 degrees apart and operates under a vacuum environment. The orientation of parts depends on the assembly of the specific bearing application.

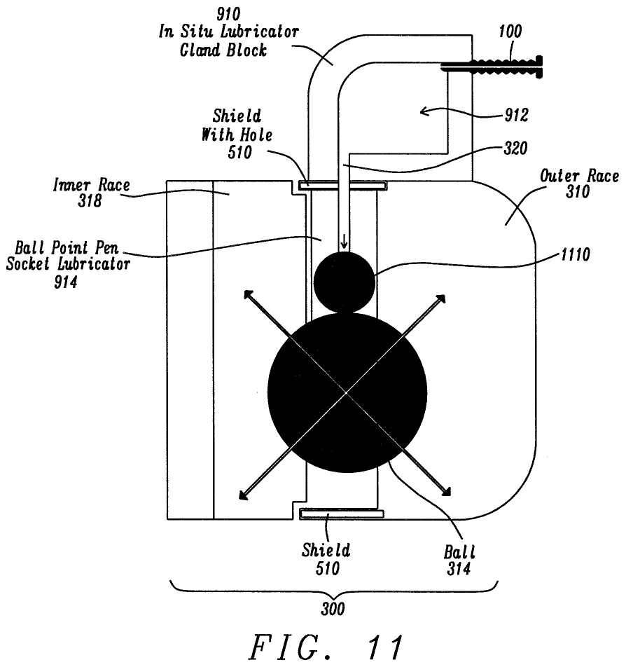

An isometric view of the lubricator gland block being utilized on a bearing is shown in FIG. 10. The lubricator block 910 can be positioned on top of the outer race 310 without contacting the inner race 318. The gland block could also be attached to the inner wall of the bearing assembly above the bearing 300, not in contact with the bearing itself.

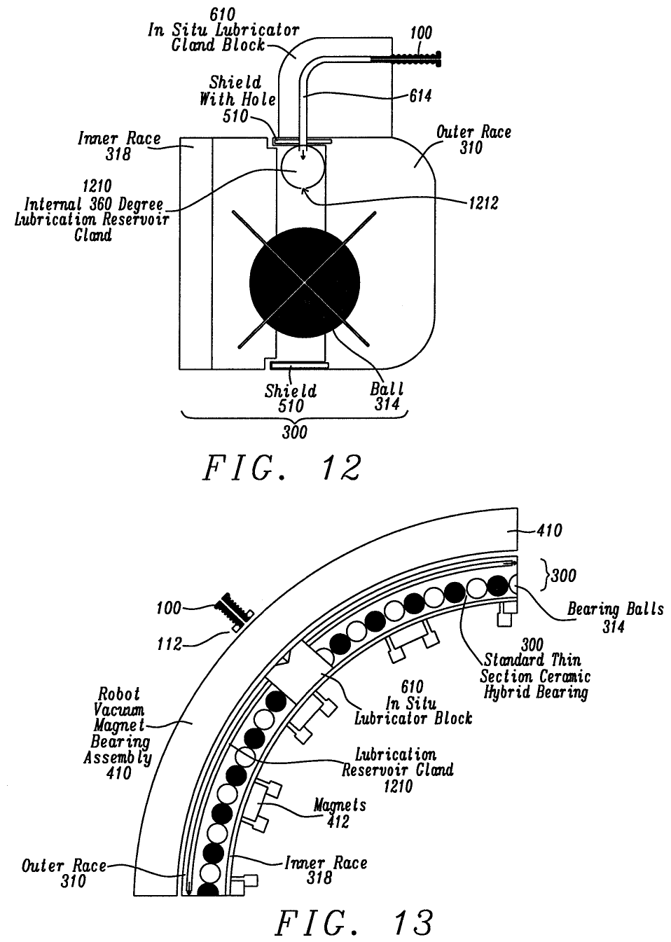

A fourth embodiment shown in FIG. 11 in a cross sectional view incorporates an automatic lubricator ball 1110. Lubricant can be injected with a grease gun or syringe and flows continuously through the adapter 100, gland block 910 including gland 912, through a stainless steel tube 320 which is inserted through a hole in the top shield 510, and finally into the ball point pen socket lubricator 914 which contains the lubricator ball 1110. The lubricator ball 1110 is held in place by two prongs located 180 degrees apart within the pen socket 914. The bearing ball 314 pulls lubricant from the lubricator ball 1110 as they rotate with one another. The lubricator ball 1110 is shaped to fit between the shield 510 and ball bearings 314, but the presence of a shield is not required for this or any embodiment.

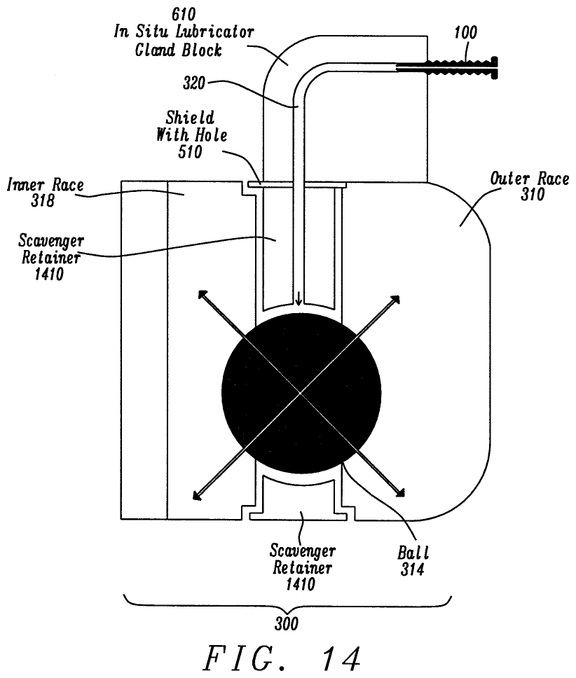

A fifth embodiment of the disclosed lubrication system is the addition of an internal 360 degree ring reservoir gland. FIG. 12 provides a cross sectional view of this ring gland 1210. The gland preferably consists of tubing that runs adjacent to the outer race 310 of the 4 point thin section bearing 300, in the space above the bearing balls 314 and shield with hole 510. Lubricant flows through the lubricator adapter 100, into the channel 614 which continues through the lubricator block 610, through a hole in the upper shield, and into the ring reservoir gland 1210 which has a series of evenly spaced holes 1212 to allow lubricant to disperse onto the bearing balls 314. The size and quantity of these holes depends on the lubricant viscosity and will control the rate of lubricant release. As an example, a 6 inch inner diameter bearing could have tubing with a diameter of 0.0615 inches and have six equally spaced holes 0.0153 inches in diameter. The lubrication gland for bearings with diameters between 8 and 16 inches could, for example, be stainless steel tubing up to 0.0770 inches in diameter with 8 equally spaced holes of diameter 0.0192 inches. The extra holes provide extra lubrication for larger bearings. The quantity and size of the holes and the size of the tubing are mostly dependent on application requirements. FIG. 13 illustrates a top view of this embodiment on a thin section bearing 300 mounted on a robot vacuum magnet assembly 410. The ring reservoir gland 1210 is seated along the outer race 310 of the thin section bearing 300. Lubricant flows through in situ lubricator 100, into the lubricator block 610, and into the ring gland 1210. The ring gland can be connected in a variety of ways, including a nipple connecting the gland to the shield, spot welds connecting the gland to the shield, or a tubing construction that is preformed to make tight contact with the outer race, holding the tubing in place within the race.

A sixth and final embodiment included in this lubrication system is the addition of a lubricant scavenger retainer shown in a cross sectional view in FIG. 14. Lubricant is injected into the lubricator adapter 100, flows into the channel 320 which passes through the lubricator block 610, through a hole in the top shield 510 and through a scavenger retainer 1410. About 70% of the space that is normally above and below the bearing balls is filled in by the scavenger retainer. This retainer is shaped to fill the void and runs along the outer race 310 of the thin section bearing 300, without making contact with the inner race 318. It is important that there is still separation between the inner and outer race so they can rotate freely of each other. The reduced space allows lubricant to stay close to the ball bearings 314 for more consistent use. More lubricant is available to be drawn to the balls through creeping and bouncing of the grease between the balls. This design helps increase the life of the bearing through the increased availability of lubricant due to the reduced volume of empty space.

The advantages of one or more embodiments of the present disclosure include the elimination of an expensive 48-hour thin section bearing replacement from every 6 to 60 months to a two-hour re-lubrication procedure once a year. The disclosure also eliminates run-to-failure practices, which are unpredictable and unreliable methods to get the maximum life out of a bearing. The life of the bearing is no longer dependent on the life of the lubrication, and instead depends on the life of its mechanical components. The implementation of this disclosure allows the life of a thin section bearing to be reliably extended from 6 months to life (ten plus years) nullifying the need to purchase and replace expensive bearings every 6 months. The maintenance procedure required to replace a thin section bearing is extremely expensive and invasive. In a semiconductor assembly application, in particular, the procedure requires a total recalibration of the robotic system, replacement of tooling on the chamber walls, and burn-ins once the chamber has been returned to a state of vacuum. The disclosure will significantly improve predictability, productivity and reliability, reduce downtime of expensive systems, allow personnel to be utilized more effectively, save on tool cleaning costs and conserves all the expensive and valuable components and resources that are used in manufacturing thin section bearings.

While particular embodiments of the present disclosure have been illustrated and described, it is not intended to limit the disclosure, except as defined by the following claims.

What is claimed is:

1. A lubrication system for a rolling element bearing comprising an outer race, and inner race and a plurality of rolling elements within them mounted on a bearing housing, comprising:
a channel through said bearings outer race and the outer surface of said bearing housing, for adding lubricant to said bearing.

2. The lubrication system of claim 1 further comprising a tube placed inside said channel.

3. The lubrication system of claim 1, further comprising a threaded hollow screw component inserted into said channel.

4. The lubrication system of claim 3, further comprising a lock nut on the threaded hollow screw component, for tightening said threaded screw component to bearing housing and securing it to said outer bearing race.

5. The lubrication system of claim 1, further comprising a cap or plug over an opening in said channel at an outer surface of said outer housing, to prevent said lubricant from leaking out of said channel.

6. The lubrication system of claim 1, wherein said rolling element bearing is a thin section bearing.

7. The lubrication system of claim 1 wherein said plurality of rolling elements comprise bearing balls.

8. A robot vacuum magnet bearing assembly or housing, comprising the rolling element bearing of claim 1.

9. A lubrication system for a rolling element bearing comprising an outer race, and inner race and a plurality of rolling elements with shields or seals, mounted on a housing comprising:
a channel through said outer race and an outer surface of said housing, for adding lubricant to said bearing;
and a lubrication block comprising a second channel, connecting said first channel to said bearing.

10. The lubrication system of claim 9 wherein said first and second channels are formed at a non-zero angle to one another.

11. The lubrication system of claim 9, further comprising a lubricator gland block inside said lubrication block.

12. The lubrication system of claim 9, further comprising:
a lubricator ball located above said plurality of rolling elements;
a ball point tip socket to hold the lubricator ball in place; and
prongs placed 180 degrees apart to hold the ball point tip socket in place.

13. The lubrication system of claim 9, further comprising:
a tube located along an inner surface of the outer race, and connected to the second channel; and
one or more holes along the bottom of the tube for releasing lubricant onto the plurality of rolling elements.

14. The lubrication system of claim 13, wherein the tube is made of stainless steel.

15. The lubrication system of claim 13, wherein the tube is connected to the second channel above through a nipple.

16. The lubrication system of claim 13, wherein the tube is connected to the second channel with spot welds

17. The lubrication system of claim 9, further comprising a lubricant retainer for retaining and scavenging lubricant for use by the plurality of rolling elements.

18. The lubrication system of claim 18, wherein the lubricant retainer is a bearing retainer with arches removed.

19. The lubrication system of claim 9 further comprising a tube placed inside said first channel.

20. The lubrication system of claim 9, further comprising a threaded hollow screw component inserted into said first channel.

21. The lubrication system of claim 20, further comprising a lock nut on the hollow threaded screw component, for tightening said threaded screw component to said bearing housing and securing it to said outer race.

22. The lubrication system of claim 9, further comprising a cap or plug over an opening in said first channel at an outer surface of said outer housing, to prevent said lubricant from leaking out of said first channel.

23. The lubrication system of claim 9, wherein said rolling element bearing is a thin section bearing.

24. The lubrication system of claim 9 wherein said plurality of rolling elements comprise bearing balls.

25. A robot vacuum magnet bearing assembly or bearing housing, comprising the rolling element bearing of claim 9.
